(19) United States
(12) Patent Application Publication
(10) Pub. No.: US 2003/0120374 A1
(43) Pub. Date: Jun. 26, 2003

(54) Method for Producing a Bore

(75) Inventors: Ulrich Klink, Neuffen (DE); Gerhard Flores, Ostfildern (DE)

(73) Assignee: Maschinenfabrik Gehring GmbH @$amp; Co. KG, Ostfildern, 73760 (DE)

(21) Appl. No.: 10/248,087

(22) Filed: Dec. 17, 2002

(30) Foreign Application Priority Data
Dec. 20, 2001 (EP) 01 130 399.7

(51) Int. Cl. G06F 19/00

(52) U.S. Cl. 700/182; 700/164

(57) ABSTRACT

### Abstract of Disclosure

In a method for producing a bore, wherein the bore in an unloaded state has an initial shape and in an operational state has a nominal shape deviating from the initial shape, first a deformation of the bore to a nominal shape present in an operational state is determined. Based on the nominal shape and the deformation determined in the first step, the initial shape is determined. The bore is then transformed by a processing method to the initial shape.

### Background of Invention

1. Field of the Invention.

The invention relates to a method for machining a bore, in particular, the cylinder bore of a reciprocating piston machine, wherein the bore in the unloaded state has an initial shape and in the operational state has a nominal shape which deviates from the initial shape.

2. Description of the Related Art.

In particular in the case of cylinder bores of reciprocating piston machines such as internal combustion engines or compressors, the goal is to obtain excellent tribological conditions by providing uniform and minimal play between piston and cylinder. Since, as a result of loads caused by stress and temperatures in the operational state, the cylinder bore is deformed, the shape of the bore which is cylindrical in the unloaded state deviates in operation from the cylindrical shape.

In order to provide a cylindrical bore during operation, it is proposed in Japanese patent document 11267960 to clamp the bore during machining with original tension screws and the original torque as employed in the operational state. In order to additionally simulate deformation caused by temperature effects, it is known to heat the workpiece by means of hot honing oil. However, this method for manufacturing the bore causes a great expenditure as a result of the required devices. This machining process results in high costs. Because of the relatively long heating period to temperatures of 80ºC to 140ºC, the required safety devices, the seal wear, and the required temperature conditioning, this method is used only for custom machining of high-quality engines. The actual deformation state in operation is moreover simulated only insufficiently by the aforementioned devices.

### Summary of Invention

It is an object of the present invention to provide a method of the aforementioned kind which enables the manufacture of bores with an ideal shape in the operational state under deformation with minimal expenditure.

In accordance with the present invention, this is achieved in that the deformation of a bore to the nominal shape in the operational state is determined, the initial shape is determined by means of the nominal shape and the deformation, and the bore is transformed to the initial shape by means of a machining method.

The method proposes that for a certain bore the deformation in the operational state is to be determined, and, based on the deformation, the initial shape, i.e., the shape to be machined, which corresponds to the shape before mounting, is to be determined. Determining the deformation and the initial shape must be performed for each bore geometry and operational state only once, respectively. In particular for mass-produced parts the expenditure with regard to clamping and heating of each bore during machining is lowered significantly. Since the deformation state must not be present at the machining device itself, the deformation state can be determined much more precisely so that finishing of bores, which indeed have a predetermined geometry in the operational state, is possible.

According to one embodiment of the invention, it is provided that the nominal shape, i.e., the shape under operating conditions, is cylindrical. A different configuration variant provides that the initial shape is cylindrical. In particular in the case of a cylindrical nominal shape, it is proposed to determine the initial shape theoretically.

Expediently, the deformation is determined experimentally. In particular, the deformation is determined by static pressing and measuring of the obtained geometry. In order to obtain especially precise deformation data, it can be advantageous to determine the deformation by dynamic measurement in operation. The deformation can also be determined theoretically, in particular, by computer simulation.

It is provided that the initial shape is produced by temporallylocally varying processing parameters. In principle, the initial shape can be manufactured by methods such as defined cutting, grinding, spark erosion, or honing. The processing method is however particularly a honing method, wherein the tool is a honing tool that is arranged on a spindle and comprises at least one honing stone which is pressed at an advancing pressure against the wall of the bore. It is provided that the advancing pressure of at least one honing stone can be varied during the course of honing. The advancing pressure is varied, in particular, as a function of the rotational position of the spindle. In this way, different inner bore radii can be obtained in the circumferential direction of the bore. Expediently, the advancing pressure is varied as a function of the lifting position of the spindle so that different inner bore radii are produced in the axial direction of the bore.

A honing machine for performing the method comprises one to four honing stones wherein the advancing pressure for each honing stone is separately controlled. The separate control of the advancing pressure for each honing stone enables different inner bore radii for small areas of the bore periphery. The length of the honing stone in the direction of the bore is particularly smaller or identical to the length of individual bore sections with approximately identical geometry. As a result of the minimal length of the honing stones in the axial direction of the bore different inner bore diameters can be realized.

### Brief Description of Drawings

Fig. 1 is a section of a bore having initial shape.

Fig. 2 is a section along the line II-II of Fig. 1.

Fig. 3 is a schematic illustration of a section along the line III-III or III'-III' of Fig. 1.

Fig. 4 shows a schematic illustration of a section along the line IV-IV or IV'-IV' of Fig. 1.

Fig. 5a section of a bore having nominal shape (operational shape).

### Detailed Description

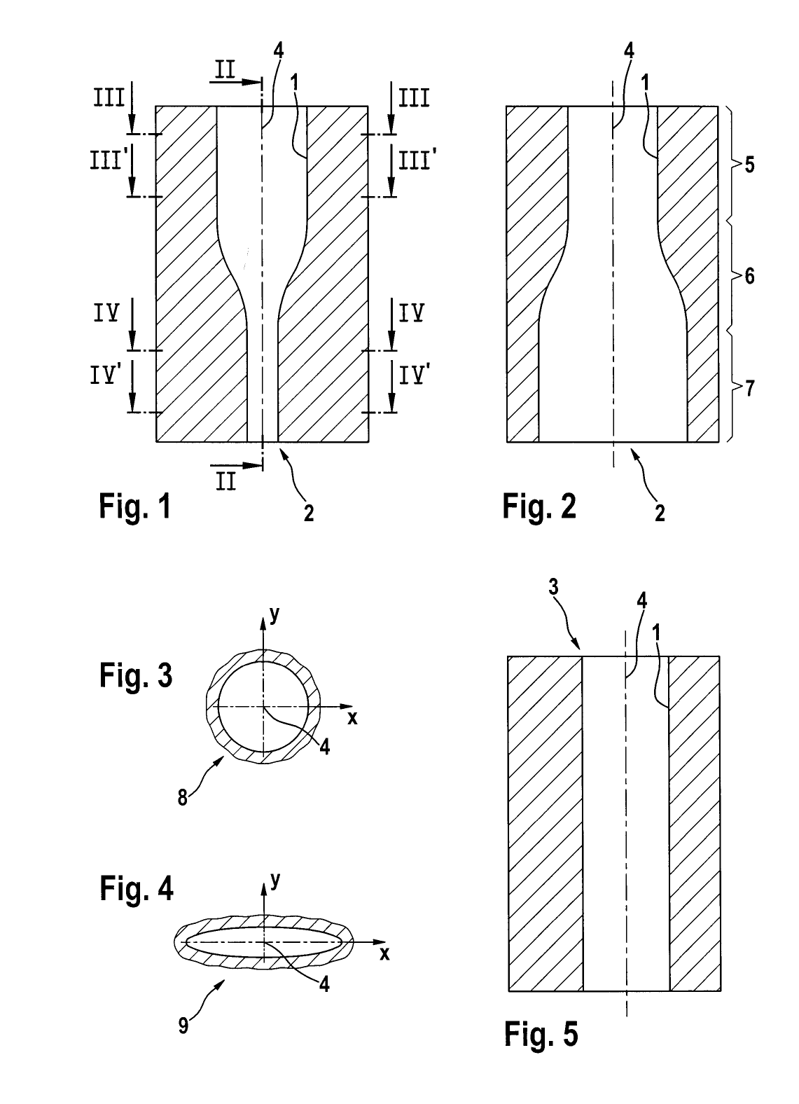

For the manufacture of a bore 1 with the cylindrical nominal shape 3 illustrated in Fig. 5, which nominal shape results by deformation in the operational state, first the initial shape 2 of the bore 1 illustrated in Figs. 1 and 2 is determined. The initial shape 2 is the shape of the bore 1 before being mounted. The initial shape 2 is substantially cylindrical in its upper area 5 and elliptical in its lower area 7. The illustration of the deviation of the elliptical shape from the cylindrical shape is not true to scale in Figs. 1 and 2 but is shown greatly enlarged. In fact, the deviation is in the range of approximately 8 to 60 μm. The central area 6 is a transition area from the cylindrical cross-sectional shape 8 to the elliptical cross-sectional shape 9. The cylindrical cross-sectional shape 8 is illustrated in Fig. 3 and the elliptical cross-sectional shape 9 in Fig. 4.

For determining the initial shape 2 the deformation of the nominal shape 3 in the operational state is determined. The deformation can be determined experimentally by static clamping. For this purpose, a bore, in particular, the cylinder bore of a motor block, in the nominal shape 3, in particular, in cylindrical shape, is produced. Expediently, the bore is machined by honing. The bore is then exposed to loads which occur during operation. For this purpose, the cylindrical bore can be clamped, for example, by means of the cylinder head, wherein the tension screws used for fixation are tightened with the torque predetermined for operation with use of the original seals. Depending on the operational state and the required precision, additionally or alternatively, the component can be heated to operating temperature and/or a pressure loading can be carried out with the pressures that predominantly occur in the operational state. The thus caused shape softening is determined by shape testing measurements.

However, the deformation can also be determined by dynamic measuring of the shape change in the operational state. The dynamic measurement is carried out particularly during firing in the case of cylinder bores. The deformation can also be determined theoretically, in particular, by computer simulation. The computer simulations simulates the deformation during the firing operation with all detectable parameters. Expediently, the method with which the deformation is determined is selected as a function of the required precision and of the expenditure required for the determination.

Based on the determined deformation and the nominal shape 3, the initial shape 2 is theoretically determined. The initial shape 2 is then produced by means of a processing method, in particular, by means of a honing method. The honing machine for processing the bore comprises one to four honing stones. The advancing pressure with which each honing stone is pressed against the wall of the bore 1 can be controlled for each honing stone separately. The honing tool carries out an oscillating movement in the direction of the axis 4 of the bore 1 and a rotary movement about the axis 4. For machining the upper area 5 of the bore 1, all honing stones are pressed with the same advancing pressure against the wall of the bore 1. The advancing pressure is not varied for the duration of machining. In this way, the cylindrical cross-sectional shape 8 illustrated in Fig. 3 results. For producing the elliptical cross-sectional shape 9 which is illustrated in Fig. 4, the advancing pressure on the honing stones is increased in the direction of the axis X and is decreased in the direction of the axis Y. In the central area 6 the advancing pressure is controlled additionally as a function of the travel position of the spindle on which the honing tool is fixed. Since the bore geometry in the central area 6 changes continuously, the honing stones with their minimal axial expansion are used. For obtaining a higher precision, the tool has a lower and/or an upper guide.

When bores are required which have an inner contour which deviates from that of a cylindrical shape, the contour illustrated in Fig. 5 can represent the initial shape and the bore shape resulting under load can be the contour illustrated in Figs. 1 and 2 which then represents the nominal shape.

Basically, other machining processes which enable the manufacture of an inner contour deviating from the cylinder shape can be used also for manufacturing the bore by means of the inventive method.

While specific embodiments of the invention have been shown and described in detail to illustrate the inventive principles, it will be understood that the invention may be embodied otherwise without departing from such principles.

Claims

1. WHAT IS CLAIMED IS:
1.A method for producing a bore, wherein the bore in an unloaded state has an initial shape (2) and in an operational state has a nominal shape (3) deviating from the initial shape (2), the method comprising the steps of:
a)determining a deformation of a bore to a nominal shape (3) present in an operational state;
b)based on the nominal shape and the deformation determined in the step a), determining the initial shape; and
c)transforming the bore with a processing method to the initial shape (2).

2.The method according to claim 1, wherein the nominal shape (3) or the initial shape (2) is cylindrical.

3.The method according to claim 1, wherein in the step b) the initial shape (2) is determined theoretically.

4.The method according to claim 1, wherein in the step a) the deformation is determined experimentally.

5. The method according to clean 4, wherein in the step a) the deformation is determined by static pressing and measuring of the obtained geometry.

6. The method according to claim 4, wherein in the step a) the deformation is realized by heating to operational temperature.

7. The method according to claim 4, wherein in the step a) the deformation is determined by dynamic measuring during operation.

8. The method according to claim 1, wherein in the step a) the deformation is determined theoretically.

9.The method according to claim 8, wherein computer simulation is used in the step a).

10. The method according to claim 1, wherein in the step c) the initial shape is processed by employing temporally and locally varied processing parameters.

11. The method according to claim 1, wherein in the step c) honing is used, wherein the tool is a honing tool, arranged on a spindle and comprising at least one honing stone pressed with an advancing pressure against a wall of the bore (1).

12. The method according to claim 11, wherein in the step c) the advancing pressure of at least one honing stone is varied during the course of processing.

13. The method according to claim 12, wherein the advancing pressure is varied as a function of a rotational position of the spindle.

14. The method according to claim 13, wherein the advancing pressure is varied as a function of a lifting position of the spindle.

15. The method according to claim 12, wherein the advancing pressure is varied as a function of a lifting position of the spindle.

16.The method according to claim 1, wherein the bore is a cylinder bore of a reciprocating piston machine.
